(19) United States
(12) Patent Application Publication
(10) Pub. No.: US 2018/0304579 A1
(43) Pub. Date: Oct. 25, 2018

(54) DAMPING SKIN SYSTEM FOR PROTECTING COMPOSITE PARTS

(71) Applicant: SKF AEROSPACE FRANCE, Saint Vallier (FR)

(72) Inventors: Jean-Luc BRIAN, Montricoux (FR); Valia FASCIO, Montauban (FR); Philippe VIE, Toulouse (FR); Guy VALEMBOIS, Toulouse (FR)

(21) Appl. No.: 16/016,892

(22) Filed: Jun. 25, 2018

Related U.S. Application Data
(63) Continuation of application No. 12/989,023, filed on Oct. 21, 2010, now abandoned.

(51) Int. Cl. B32B 5/26; B32B 5/30; B32B 5/22; B32B 5/16; B32B 5/02; F41H 5/04; B64D 7/00; B32B 7/12; B32B 3/20

(52) U.S. Cl. CPC B32B 5/26; B32B 2605/18; B32B 2307/718; B32B 2307/558; B32B 2307/50; B32B 2307/306; B32B 2307/202; B32B 2264/105; B32B 2264/10; B32B 2264/02; B32B 2262/0269; B32B 2260/046; B32B 2260/025; B32B 5/30; B32B 5/22; B32B 5/16; B32B 5/02; F41H 5/04; B64D 7/00; B32B 7/12; B32B 3/20; Y10T 428/24496; Y10T 428/249971; Y10T 428/249974; Y10T 428/249973

(57) ABSTRACT

Damping skin for protecting composite parts includes a composite material having at least two superposed layers, namely a first layer formed from the juxtaposition of hollow spheres, which is intended to be applied and fixed, either directly or indirectly, to the surface of the part to be protected and a second layer covering the first and formed from a wall made of a material having plastic deformation properties.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The object of this invention is a damping skin for protecting composite parts.

In the aeronautical field, composite materials increasingly tend to replace metal materials, because they permit a lightening of the structures for equal or superior mechanical performance. Over the last few years, a considerable effort was made to extend the life span of composite structures and anticipate their damage.

To this end high performance materials are used, such as carbon combined with a binder. However, during the impact of a projectile on a composite structure, or during a shock, the energy produced by the impact or the shock on the composite part is dispersed by a microscopic damaging of the part. The effect of this is a micro-fissuring of the matrix, a breaking of the fibers or a de-lamination of the folds. Thus, whether of considerable or small energy, any impact on a composite is significant because it can lead to the appearance of internal de-laminations which can then spread under cyclic stress and bring about the ruin of the part. In order to avoid the consequences of such shocks, structures are oversized so as to anticipate the consequences of mechanical shocks. For this reason, the advantage of lightness of composite materials is considerably reduced.

Resistance to impacts and to shocks is a property that can be adjusted according to the mechanical and/or economic requirements of the final application. Composite materials based on aramid polymer fibers, which have an excellent resistance to impacts combined with good mechanical performances, or glass fibers can thus be used in order to improve impact resistance.

The damping skin according to the invention aims at protecting the composite structures against projectile impacts, gravel for example, or from shocks, with volatiles in the aeronautical field for example, yet offering the following advantages: easy implementation at the stage of manufacturing, even for the parts having complex shapes, significant mechanical shock absorption capacity without deterioration of the substrate, qualifying the parts in conformity with aeronautical requirements, visualization of impact effects and simplification of maintenance operations.

To this end, this invention uses known properties of hollow spheres, implemented in the manufacturing of shock absorbers, or alveolar materials.

### 2. Description of Related Art Including Information Disclosed Under 37 CFR 1.97 and 37 CFR 1.98

From FR 2 585 445 in the name of one of the Applicants is thus known a modular composite material, of small specific gravity yet having good mechanical characteristics, which consists of a plurality of hollow balls geometrically arranged according to a distribution similar to the distribution of the compact crystallographic type and fixed to each other exclusively through their contact areas.

Also known, from FR 2 615 787 still in the name of one of the Applicants, is a modular product as well as several manufacturing processes, consisting of the juxtaposition of hollow balls according to a layout plane having a single layer of the crystallographic type, and connected to each other near their contact areas by meniscuses formed of a flexible binder, so as to form a sheet having good mechanical characteristics combined with a small specific gravity.

Also known, from GB 1 070 874, is a volume alveolar material formed of a group of balls fixed to each other, for the purpose of obtaining a material having a small weight.

All these composite materials, irrespective of the aforesaid document in question, have interesting characteristics of mechanical resistance and lightness permitting them in particular to constitute an advantageous alternative to honeycomb structure materials; however, they do not permit to cope with the problem of protecting a composite-material part.

In fact, in case of impact on parts manufactured according to the methods described in these documents, the structure itself of said parts can be deteriorated, so that a repair may not be possible, and in order to cope with this disadvantage nothing the part could be done but oversizing, with all the disadvantages ensuing therefrom, as it has already been mentioned.

### BRIEF SUMMARY OF THE INVENTION

The damping skin for protecting composite parts according to the invention is characterized essentially in that it consists of a composite material comprising at least two superposed layers, i.e. a first layer consisting of a juxtaposition of hollow spheres designed to be applied and fixed, directly or indirectly, to the surface of the part to be protected, and a second layer, covering the first one, and consisting of a wall made of a material having plastic deformation properties.

According to an additional feature of the damping skin according to the invention, the first layer consists of the superposition of several layers, each consisting of the juxtaposition of hollow spheres, each of said layers of hollow spheres being or not separated from the other layer or layers of hollow spheres by an intermediate wall.

It should be noted that each layer of hollow spheres can be analogous to the modular material, in the form of a sheet, described in FR 2 615 787, and made according to any of the methods described in said document, or also according to another method.

It should also be noted that a sheet of this modular material described in said document could not be sufficient on its own to ensure the protection of the composite part that it covers. In fact, according to the invention, it is the combination of at least one layer of hollow spheres and a wall made of a material having plastic deformation properties that permits to solve the problem raised. Thus, during an impact or a shock, the external wall permits, through its deformation, to diffuse the energy of the impact in order to transmit it to a great number of hollow spheres, which will absorb it.

According to the invention, the first layer of the damping skin according to the invention can be fixed indirectly on the part to be protected, by means of a third layer, on one side of which is fixed the first layer consisting of hollow spheres, whereas its other side includes means of integral connection permitting its fastening, and therefore that of the damping skin on the surface to be protected, means of integral connection which can be designed reversible if, for example, fastening should be temporary.

The purpose of the first layer, directly or indirectly glued on the substrate to be protected, is to absorb the energy generated by the impact, and dispersed by the external wall being crushed without affecting the substrate. This layer also facilitates the control of the distance between the substrate and the second layer yet permitting an easy shaping irrespective of the geometry of the composite part to be protected.

This layer has a sufficient mechanical resistance to ensure cohesion between the two layers, but is fragile enough not to affect the substrate during its crushing under the effect of an impact.

It is therefore important to find the right dimensions for the hollow spheres, the thickness of their shell for example, depending, of course, on the material of which they are made, so that the latter are crushed, at least locally, during the impact in order to protect the composite structure on which the skin is fixed.

Besides the protection of the structure, the damping skin according to the invention is an indicator of the condition of the composite structure after impact.

In fact, it is possible to adjust the energy absorption capacity of the damping skin by altering the thickness of the hollow spheres core, the intrinsic properties of hollow spheres, or the selection of diameters of hollow spheres. This combination of hollow spheres and second layer permits to create an effective protection of composites against gravel impacts, in particular, or shocks with other objects.

The use of hollow spheres has numerous advantages. Besides their resistance to impacts, the hollow spheres offer certain lightness. They can be made of metal or of synthetic materials (polymer, ceramic or elastomer for example) or minerals.

The hollow spheres have diameters varying preferably between 1 and 6 mm. They can all have the same diameter, or not. The diameter of the spheres defines the distance between the second layer and the substrate. This controlled thickness of the layer of hollow spheres should be adjusted according to the applications, in order to guarantee that the substrate will not be deteriorated during impacts.

The range of the diameter of hollow spheres between 1 and 6 mm permits to consider the use of the damping skin in areas of intense curvature. It is therefore possible, using the skin according to the invention, to match even the most complex shapes.

Another advantage of the invention is its small sensitivity to the impact angle. In fact, the volume of hollow spheres being isotropic, its performance in terms of energy absorption will not be conditioned by the impact angle. This is not the case with honeycomb based solutions, which tend to collapse under the influence of large impact angles.

The hollow spheres are assembled between each other, and possibly to the walls or surfaces, which they are in contact with, by gluing using a polymerized structural resin for example, or by any other technique that permits to bind them. The quantity of resin coating the spheres is controlled and, in an embodiment, is in the form of a meniscus limited to the different contact points. This resin has a triple function: it permits not only to ensure the cohesion of the hollow spheres between each other, but also the connection between the layers, the cohesion of the hollow spheres with the substrate and the second layer.

It should be noted that according to a variant, the space that remains between the hollow spheres and the second layer or the intermediate wall, and the object to be protected or the third layer, is filled with a compressible material, of a compression resistance that is lower than that of the hollow spheres it encloses, a foam or an elastomer for example.

As to the second layer, or external wall, this is preferably a layer of a material having a high plastic deformation capacity. Its deformation or its resistance to tearing permits to transform the energy from the shock into local deformation. In an embodiment, said second layer can be made of aramid tissues stratified between them. The number of layers of tissue, their thickness and their texture will be chosen based on the type of impact they will have to endure.

Part of the energy, preferably the maximum, of the impact is absorbed by the bi-component skin hollow spheres/second layer, which permits to avoid the de-lamination of the composite structure on which the damping skin is applied.

In an embodiment, said second layer is made of an aramid polymer, Kevlar type for example. The utilization of an aramid-based layer permits the transformation of the energy of the impact (local phenomenon) into a plastic deformation of said skin. Thus, part of the volume of hollow spheres is crushed and the area finally affected by the impact is an area that is larger than the initial impact area.

In another embodiment, the second layer, or external wall, consists of a composite material incorporating components that give it specific insulation and/or conductivity properties according to the utilization of the damping skin. Thus, non-restrictively, said second layer or external wall can have a certain heat resistance, or be electrically conductive.

The damping skin according to the invention facilitates the maintenance of the parts after impact. In fact, the simple assessment of the depth of the impacted area permits to conclude whether there is or not a deterioration of the substrate under the impact area.

In fact, in case of an impact, the second layer, or external wall, is deteriorated, and this local breaking, or the plastic deformation of the second layer, permits a clear visualization of the impact area.

Besides, following the impact, if the layer or layers of hollow spheres are damaged, it is visually possible for a maintenance operator to check whether the composite structure is damaged and possibly replace, at least locally, the hollow spheres and the second layer destroyed during the impact.

After the impact, the maintenance of the impacted part is facilitated by the presence of the two layers of a quite different nature.

The first layer is fragile whereas the second has a significant mechanical resistance. The second layer can be partially removed thanks to a tool of the router type, whose cutter does not extend beyond the thickness of the spheres. It is thus guaranteed that the portable electric cutting tool will not touch the substrate.

Scraping with manual tools permits to remove the deformed hollow spheres, and the curettage thus made permits the reconstruction of the wall by gluing of the missing hollow spheres and laying of a second layer.

The damping skin is not necessarily disadvantageous in terms of mass, due to the small weight of the hollow spheres and of the external layer.

In general, and in particular for applications in the aeronautical field, the damping skin according to the invention can allow the resizing of the composite parts it protects. Said parts are now oversized in order to continue to perform their function after impact.

This invention can be applied, non-restrictively, in the aeronautical field, advantageously for absorbing the impacts of projectiles, in particular of gravel or volatiles, on composite parts of aircrafts, undercarriage for example, but also on other parts capable of being exposed to impacts or shocks.

Advantageously, the damping skin can be of a thickness that is variable according to the portion of the part in question. In fact, certain portions of a part can be exposed more than others, and therefore need to be better protected.

Thus, non-restrictively in the aeronautical field for example, the front portions of the parts are practically the only ones that are exposed, since the impacts are capable of creating damages that only occur practically during movements starting from a certain speed. It would be absolutely possible to cover entirely a part exposed to impacts, with, however, the disadvantage, due to the covering of the sides of said part which are only slightly exposed, of increasing the surface that is actually exposed.

Preferably, the damping skin according to the invention has areas of different thickness, these thickness variations depending on the degree of exposure to impacts of the portions of the part these areas should cover. Thickness variation is carried out essentially by varying the number of layers of hollow spheres.

The features of the damping skin according to the invention will become more evident from the following description, which refers to the attached drawing, which represents several non-restrictive embodiments thereof.

### BRIEF DESCRIPTION OF THE SEVERAL VIEWS OF THE DRAWINGS

FIG. 1 represents a schematic cross-sectional view of a portion of an object covered with a damping skin according to the invention.

FIG. 2 represents a schematic cross-sectional view of a portion of an object covered with a variant of the same damping skin.

FIG. 3 represents a schematic cross-sectional view of a portion of an object covered with another variant of the same damping skin.

FIG. 4 represents a schematic cross-sectional view of an enlarged detail of the same damping skin.

FIG. 5 represents a schematic cross-sectional view of the same portion of an object covered with a damping skin, during an impact.

FIG. 6 represents a schematic cross-sectional view of a portion of an object covered with another variant of the same damping skin.

### DETAILED DESCRIPTION OF THE INVENTION

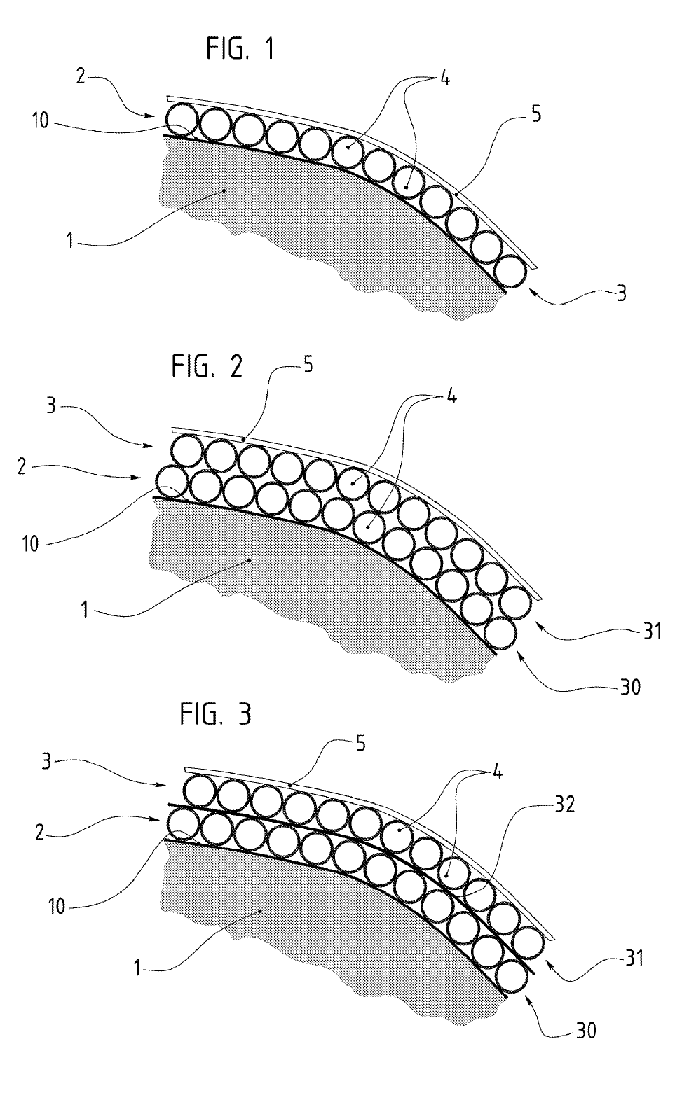

FIG. 1 shows an object 1, a part made of a composite material for example, whose external wall 10 is covered with a damping skin 2 according to the invention.

Said damping skin 2 consists of two layers, a first layer 3 consisting of the juxtaposition of hollow spheres 4, fixed to the wall 10, and a second layer 5, covering the first, and made of a material having plastic deformation properties.

The hollow spheres are of a known type, already used in the field of shock absorbers for example, they can be made of different materials, including metal or synthetic materials as well.

The layer 5 consists of a sheet which can be made in different manners, of a composite tissue, or of several composite tissues stratified between them, the number of tissues, as well as their thickness and their texture being chosen according to the use of the skin.

Said tissues are preferably, but not restrictively, made of aramid polymer.

FIG. 2 shows that, according to a variant, the first layer 3 itself consists of the superposition of two layers 30 and 31 of hollow spheres 4.

FIG. 3 shows that, in another variant, the first layer 3 also consists of the superposition of two layers 30 and 31 of hollow spheres 4, and that said two layers 30 and 31 are separated by an intermediate wall 32.

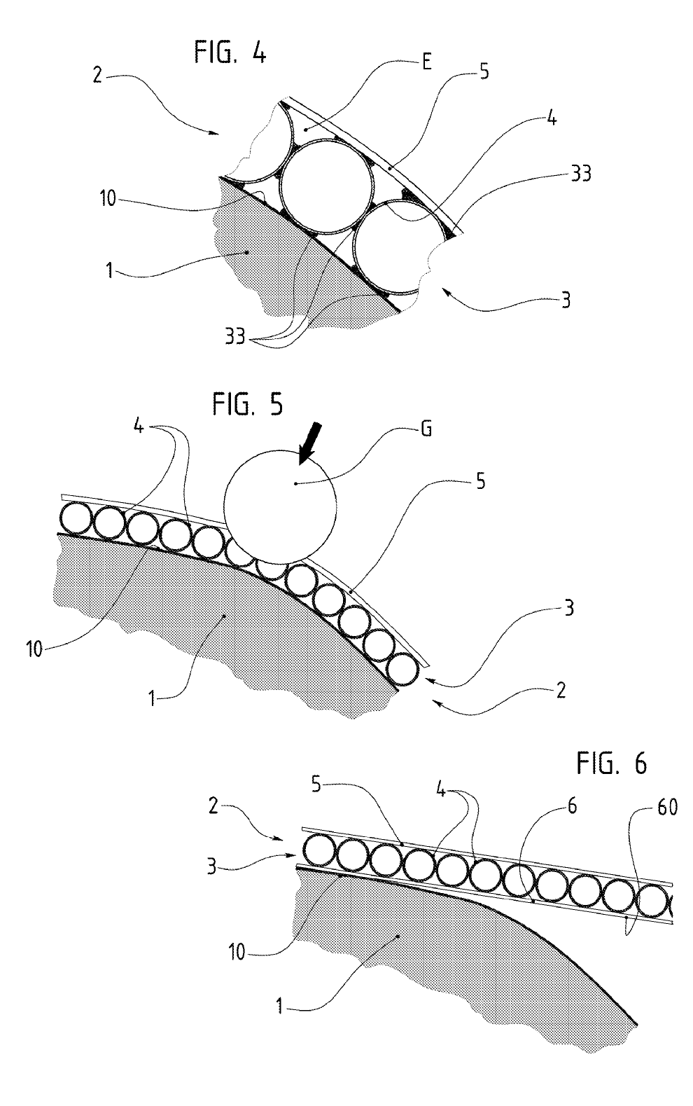

Referring to FIG. 4, it can be seen that the hollow spheres 4 are connected between them, and to the wall 10 as well as to the second layer 5, by gluing, by means of resin bonds 33 for example. The operation of gluing is made with a controlled quantity of resin, so that the bonds 33 are localized to the points of contact of the spheres between each other, and between them and the wall 10 and the wall 5, so as to form nothing but meniscuses, in order to cover only a limited portion of the spheres 4, and not to deteriorate the properties thereof.

It should be noted that the space E, delimited by the walls 10 and 5, as well as by the hollow spheres 4, can be left empty or be filled with a compressible material, with a compression resistance that is lower than that of the hollow spheres 4, such as a foam or an elastomer for example.

Referring now to FIG. 5, one can see the effect of an impact by an element G, on an object 1 covered with a damping skin 2.

Obviously, it is easy for a maintenance operator to detect an impact area and assess the extent of the damages, then to repair the damping skin 2 by removing the damaged hollow spheres 4 and replacing them, then covering with a wall part 5.

Referring now to FIG. 6, one can see a damping skin 2 according to the invention made integral indirectly with the wall 10 by means of a wall 6. The damping skin 2 thus includes two walls 5 and 6 between which a layer 3 of hollow spheres 4 is placed.

The wall 6 can have various aspects, and it can consist of various materials. Its principal feature consists in that its face 60, designed to enter into contact with the wall 10, is designed capable of being made integral with the latter.

This integral connection can be made by adhesion through gluing means the adhesion capacity of which is more or less considerable.

In case of a small adhesion, it is possible to make an integral connection reversible at will, permitting to ensure the temporary protection of an object.

The damping skin 2, comprising such a wall 6, can thus be conditioned with sheets, patches, strips etc, having possibly certain flexibility, and the face 60 of which is coated with an adhesive product.

We claim:

1. A damping skin system for protecting composite parts, said damping skin system comprising:
a substrate comprised of a first composite material and having a surface, said first composite material being comprised of a first structural component and a first resin;
a skin comprised of a second composite material and a wall layer, said second composite material being comprised of a second structural component and a second resin,
wherein said second composite material is a first layer and said wall layer is a second layer, said first layer and said second layer being superposed, said second layer covering said first layer,
wherein said second structural component is comprised of a juxtaposition of hollow spheres applied and fixed to said surface, and
wherein said second layer is comprised of a moldable and resilient material, said first composite material having more mechanical resistance than said first layer.

2. The damping skin system according to claim 1, wherein said second structural component of said first layer comprises superposition of several layers, each layer being comprised of juxtaposition of hollow spheres, each layer of hollow spheres being separable from other layers of hollow spheres by an intermediate wall.

3. The damping skin system according to claim 1, said skin further comprising:
a third layer affixed to said first layer on one side and affixed to said surface of said substrate on an opposite side, said third layer having a means for removable attachment in contact with said surface of said substrate.

4. The damping skin system according to claim 1, wherein said hollow spheres are comprised of a material selected from a group consisting of metal, synthetic materials, minerals, or a combination thereof.

5. The damping skin system according to claim 1, wherein said hollow spheres have different diameters, each layer of hollow spheres having spheres with diameters independent from other layers.

6. The damping skin system according to claim 1, wherein said wall layer is comprised of at least one sheet of a composite tissue.

7. The damping skin system according to claim 6, wherein said composite tissue is comprised of an aramid polymer.

8. The damping skin system according to claim 6, wherein said composite tissue has components having properties selected from a group consisting of insulating ability, conductivity or both.

9. The damping skin system according to claim 1, wherein said hollow spheres are assembled by gluing to at least one of a group consisting of: each other, said wall layer, and said surface of said substrate.

10. The damping skin system according to claim 9, wherein said hollow spheres are assembled by a said second resin applied at points of contact of said hollow spheres.

11. The damping skin system according to claim 1, said skin further comprising:
a compressible material filling in space remaining between said hollow spheres of said second composite material, said compressible material having a compression resistance lower than a compression resistance of said hollow spheres.

12. The damping skin system according to claim 1, wherein said second composite material of said skin has thickness, corresponding to said first composite material of said substrate.
